(19) United States
(12) Patent Application Publication
(10) Pub. No.: US 2026/0264631 A1
(43) Pub. Date: Sep. 10, 2026

(54) COMMUNICATION SYSTEM

(71) Applicant: DENSO CORPORATION, Kariya-city (JP)

(72) Inventors: Yukihiro YAMAKAWA, Kariya-city (JP); Tomoya TOKUNAGA, Kariya-city (JP)

(21) Appl. No.: 19/552,099

(22) Filed: Feb. 27, 2026

(30) Foreign Application Priority Data
Mar. 4, 2025 (JP) 2025-033824

(51) Int. Cl. B60R 16/023; B60R 16/033; H02J 3/001

(52) U.S. Cl. CPC B60R 16/0232; B60R 16/0238; B60R 16/033; H02J 3/001

(57) ABSTRACT

A communication system mounted on a movable object and multiple electronic control units communicable with each other is provided. Each electronic control unit is activated by receiving power supplied from a power supply via a relay and is stopped by cutoff of the supplied power. The communication system determines whether there is an abnormality in which the relay wrongly becomes an ON state. Upon determining that there is the abnormality, the communication system executes a power distribution stop operation including turning OFF the relay that is located upstream of a location of the abnormality in power distribution from the power supply.

### CROSS-REFERENCE TO RELATED APPLICATIONS

This application is based on Japanese Patent Application No. 2025-033824 filed in Japan on Mar. 4, 2025. The entire disclosure of the above application is incorporated herein by reference.

### TECHNICAL FIELD

The present disclosure relates to a communication system mounted on a movable object and including a plurality of electronic control units arranged to be communicable therebetween.

### BACKGROUND

A vehicle includes a number of electronic control units (hereinafter referred to as ECUs) to control onboard equipment. A technology is known to reduce power consumption of a communication system for a vehicle as a whole by transitioning some unnecessary ECUs from a wake-up state to a sleep state.

### SUMMARY

According to an aspect of the present disclosure, a communication system mounted on a movable object includes multiple electronic control units. Each electronic control unit is activated by receiving power supplied from a power supply via a relay and is stopped by cutoff of the supplied power. The communication system determines whether there is an abnormality in which the relay wrongly becomes an ON state. Upon determining that there is the abnormality, the communication system executes a power distribution stop operation including turning OFF the relay that is located upstream of a location of the abnormality in power distribution from the power supply.

### BRIEF DESCRIPTION OF DRAWINGS

Objects, features, and advantages of the present disclosure will become apparent from the following detailed description made with reference to the accompanying drawings.

FIG. 1 is a diagram schematically illustrating a configuration of a communication system according to a first embodiment.

FIG. 2 is a diagram schematically illustrating a configuration common to multiple ECUs in the communication system according to the first embodiment.

FIG. 3 is a diagram schematically illustrating functions of a power distribution control device and a management device according to the first embodiment.

FIG. 4 is a diagram illustrating a specific example of an operation control request according to the first embodiment.

FIG. 5 is a diagram illustrating a specific example of an output determination result according to the first embodiment.

FIG. 6 is a diagram illustrating a specific example of an abnormality determination results according to the first embodiment.

FIG. 7 is a diagram illustrating three stop methods in executing a power distribution stop operation according to the first embodiment.

FIG. 8 is a flowchart illustrating an example of a flow of operations related to a power leakage abnormality in the communication system according to the first embodiment.

FIG. 9 is a diagram schematically illustrating functions of a power distribution control device and a management device according to a second embodiment.

### DETAILED DESCRIPTION

A vehicle, which is an example of a movable object, includes a number of electronic control units (referred to also as ECUs) to control onboard equipment, and these ECUs are connected to a communication bus to form a communication system. In this type of communication system, a technology is known to reduce power consumption of the system as a whole by transitioning some unnecessary ECUs from a wake-up state to a sleep state. There is a configuration that performs relay control for each system as means for activating and stopping the ECU.

In contrast to a configuration that performs mechanical relay control, there is arising a technology in recent years that adopts high-performance semiconductor power switches also known as IPDs to configure various power states using software in a dynamic and low power consumption manner. IPD is an abbreviation for Intelligent Power Device. In a configuration employing the IPD, it is possible to control supply of power on an ECU-by-ECU basis by combining an activation stop control via a relay based on ON and OFF of the IPD and an activation stop control by switching over to a wake-up state or a sleep state based on a communication frame.

In a case of multi-stage control, if an abnormality related to the IPD or a communication abnormality occurs, a wrong power distribution continuation or an ECU wrong wakeup may occur, wherein the wrong power distribution continuation is such that power distribution wrongly continues and the ECU wrong wakeup is such that the ECU wrongly becomes a wake-up state. There may be a concern that the wrong power distribution continuation or the ECU wrong wakeup leads to an over-discharged battery state, i.e., run out of battery.

The present disclosure is made in view of the foregoing and has an object to provide a communication system that can prevent run out of battery even in the event of a relay-related abnormality or a communication-related abnormality.

According to one aspect of the present disclosure, a communication system mounted on a movable object is provided that includes a plurality of electronic control units arranged so that communication is performable therebetween. Each of the plurality of electronic control units is activated by receiving power supplied from a power supply via a relay and is stopped by cutoff of the supplied power. The plurality of electronic control units includes: a power distribution control device including the relay; and a management device that generates an operation control request for controlling operation of the relay and outputs the operation control request to the power distribution control device via the communication.

The power distribution control device includes an ON OFF determination unit that performs a determination as to ON and OFF of the relay based on an output value being a value related to an output of the relay. The management device or the power distribution control device includes an abnormality determination unit that determines whether or not there is an abnormality in which the relay wrongly becomes an ON state, based on a result of the determination by the ON OFF determination unit and the operation control request. Upon the abnormality determination unit determining that there is the abnormality, the management device executes a power distribution stop operation including turning OFF the relay that is located upstream of a location of the abnormality in power distribution from the power supply.

According to the above configuration, it is possible for the abnormality determination unit to detect an occurrence of such an abnormality that a relay wrongly becomes an ON state, that is, it is possible to detect an occurrence of such an abnormality that an electronic control unit supposed to be stopped wrongly becomes an active state. According to the above configuration, when the occurrence of the above-mentioned abnormality is detected, the power distribution stop operation is executed by the management device. Accordingly, the electronic control unit supposed to be stopped is stopped due to cutoff of the supply of power. Specifically, the above configuration can reliably stop unnecessary functions. Therefore, according to the above configuration, run-out of battery can be prevented even in the event of a relay-related abnormality or a communication-related abnormality.

Embodiments will be described with reference to the drawings. In the embodiments, like reference symbols are used to refer to like configurations to omit duplicated description.

### First Embodiment

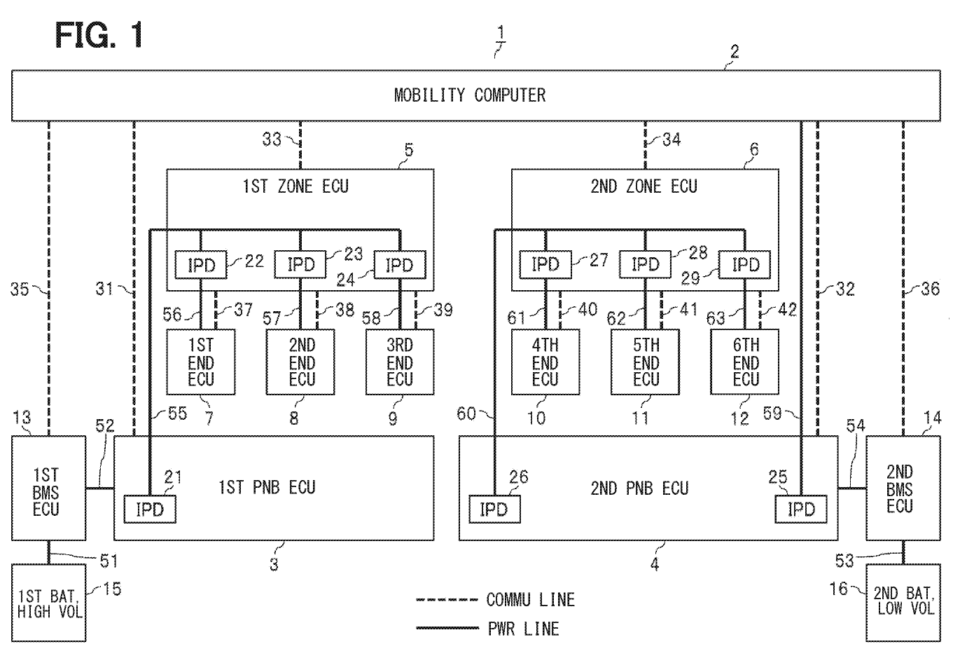

A first embodiment will be described below with reference to FIGS. 1 to 8.

### Configuration of communication system

A communication system 1 of the present embodiment is mounted on a vehicle such as an automobile. The vehicle is an example of a movable object. The communication system 1 is based on a well-known zone architecture and includes multiple ECUs arranged according to divisions called zones indicating mounting locations which are, for example, a front portion, a rear portion, a left portion and a right portion of the vehicle body. As described in detail below, multiple ECUs are arranged so that communication is performable therebetween.

As shown in FIG. 1, the communication system 1 includes various ECUs, including a mobility computer 2, a first PNB ECU 3, a second PNB ECU 4, a first zone ECU 5, a second zone ECU 6, a first end ECU 7, a second end ECU 8, a third end ECU 9, a fourth end ECU 10, a fifth end ECU 11, a sixth end ECU 12, a first BMS ECU 13, and a second BMS ECU 14.

PNB is an abbreviation for Power Net Box, and BMS is an abbreviation for Battery Management System. In the following description and drawings, "PNB ECU" and "BMS ECU" may be referred to simply as "PNB" and "BMS", so that the ECU at the end may be omitted.

The first PNB 3, the second PNB 4, the first zone ECU 5, the second zone ECU 6, the first BMS 13 and the second BMS 14 are all communicably connected to the mobility computer 2. The first end ECU b, the second end ECU 8 and the third end ECU 9 are communicably connected to the first zone ECU 5. The fourth end ECU 10, the fifth end ECU 11 and the sixth end ECU 12 are communicably connected to the second zone ECU 6.

FIG. 1 illustrates a case where the number of zone ECUs communicably connected to the mobility computer 2 is two, but the number of zone ECUs communicably connected to the mobility computer 2 may be one or three or more. Although FIG. 1 illustrates the case of three end ECUs communicably connected to each of the first zone ECU 5 and the second zone ECU 6, the number of end ECUs communicably connected to each of the first zone ECU 5 and the second zone ECU 6 may be two or less or four or more.

The multiple ECUs, including the mobility computer 2, the first PNB 3, the second PNB 4, the first zone ECU 5, the second zone ECU 6, the first end ECU 7, the second end ECU 8, the third end ECU 9, the fourth end ECU 10, the fifth end ECU 11 and the sixth end ECU 12, are activated by receiving power supplied from the first battery 15 or the second battery 16 via IPDs 21 to 29, and are stopped by cutoff of the supplied power. The first battery 15 and the second battery 16 are examples of power supply, which will be described in detail below. The IPDs 21 to 29 are examples of relays, which will be described in detail below. When the description is given on a matter common to the IPDs 21 to 29, the reference numerals at the end may be omitted, so that the IPDs 21 to 29 may be referred to collectively as IPDs.

Among the multiple ECUs, each of the first PNB 3, the second PNB 4, the first zone ECU 5 and the second zone ECU 6 includes the IPD and is an example of a power distribution control device. Among the multiple ECUs, the mobility computer 2 is an example of a management device. The mobility computer 2 generates an operation control request for controlling the operation of the IPD and outputs the operation control request to the power distribution control device via communication.

The mobility computer 2 is a control unit that can control operations of the first PNB 3, the second PNB 4, the first zone ECU 5, the second zone ECU 6, the first end ECU 7, the second end ECU 8, the third end ECU 9, the fourth end ECU 10, the fifth end ECU 11, the sixth end ECU 12, the first BMS 13 and the second BMS 14. The mobility computer 2 and the first PNB 3 are communicably connected to each other via a communication line 31. The mobility computer 2 and the second PNB 4 are communicably connected to each other via a communication line 32. The mobility computer 2 and the first zone ECU 5 are communicably connected to each other via a communication line 33. The mobility computer 2 and the second zone ECU 6 are communicably connected to each other via a communication line 34.

The mobility computer 2 and the first BMS 13 are communicably connected to each other via a communication line 35. The mobility computer 2 and the second BMS 14 are communicably connected to each other via a communication line 36. The first zone ECU 5 and the first end ECU 7 are communicably connected to each other via a communication lines 37. The first zone ECU 5 and the second end ECU 8 are communicably connected to each other via a communication line 38. The first zone ECU 5 and the third end ECU 9 are communicably connected to each other via a communication line 39.

The second zone ECU 6 and the fourth end ECU 10 are communicably connected to each other via a communication line 40. The second zone ECU 6 and the fifth end ECU 11 are communicably connected to each other via a communication line 41. The second zone ECU 6 and the sixth end ECU 12 are communicably connected to each other via a communication line 42. Each of the communication lines 31 to 42 is a communication line for communications based on communication frames conforming to a communication protocol such as CAN, CAN FD, or the like. CAN is an abbreviation for Controller Area Network, and CAN FD is an abbreviation for CAN With Flexible Data Rate.

The first BMS 13 monitors and controls a state of the first battery 15, which is, for example, a battery mounted on the vehicle. The first battery 15 is an example of a power supply and an example of a high voltage power supply having a relatively high voltage value. By the first BMS 13, the power supplied from the first battery 15 via a power line 51 is distributed to the first PNB 3 via a power line 52. By the first PNB 3, the power supplied from the first battery 15 via the first BMS 13 is distributed to the first zone ECU 5, and distributed to the first end ECU 7, the second end ECU 8 and the third end ECU 9 via the first zone ECU 5.

The second BMS 14 monitors and controls the state of the second battery 16, which is, for example, the battery mounted on the vehicle. The second battery 16 is an example of a power supply and an example of a low-voltage power supply having a relatively low voltage value. By the second BMS 14, the power supplied from the second battery 16 via a power line 53 is distributed to the second PNB 4 via a power line 54. By the second PNB 4, the power supplied from the second battery 16 via the second BMS 14 is distributed to the mobility computer 2 and the second zone ECU 6, and distributed to the fourth end ECU 10, the fifth end ECU 11 and the sixth end ECU 12 via the second zone ECU 6.

The first PNB 3 and the first zone ECU 5 are connected to each other via a power lines 55 so that the power is distributable. The first PNB 3 includes an IPD 21 interposed between the power line 52 and the power line 55. The IPD is a high-performance semiconductor power switch including a built-in protection circuit and capable of absorbing energy from an inductive load or another source. The IPD is also called a semiconductor fuse, IPS, a smart switch, and a high-side/low-side switch. IPS is an abbreviation for Intelligent Power switch. Compared to a mechanical relay having a mechanical contact, the IPD does not have the mechanical contact and thus has advantages of superior mechanical durability and quietness, as well as compact size. In addition, the IDP has a protection function that does not exist in the mechanical relay, thus ensuring a high level of reliability.

The first PNB 3 turns ON and OFF the IPD 21 based on an operation control request for the IPD 21 provided from the mobility computer 2 via the communication line 31, and switches over the first zone ECU 5 between a power-supplied state a power-cutoff state. Specifically, by turn ON of the IPD 21, the supply of power from the first PNB 3 to the first zone ECU 5 starts. By turn OFF of the IPD 21, the supply of power from the first PNB 3 to the first zone ECU 5 ends. The operation control request is for controlling the operation of the IPD and includes an IPD ON signal for instructing the ON of the IPD and an IPD OFF signal for instructing the OFF of the IPD.

The first zone ECU 5 and the first end ECU 7 are connected to each other via a power line 56 so that the power is distributable. The first zone ECU 5 and the second end ECU 8 are connected to each other via a power line 57so that the power is distributable. The first zone ECU 5 and the third end ECU 9 are connected to each other via a power line 58 so that the power is distributable. The first zone ECU 5 includes the IPD 22 interposed between the power line 55 and the power line 56, the IPD 23 interposed between the power line 55 and the power line 57, and the IPD 24 interposed between the power line 55 and the power line 58.

The first zone ECU 5 turns ON and OFF the IPD 22 based on the operation control request for the IPD 22 provided from the mobility computer 2 via the communication line 33, and switches over the first end ECU 7 between the power-supplied state and the power-cutoff state. Specifically, by turn ON of the IPD 22, the supply of power from the first zone ECU 5 to the first end ECU 7 starts. By turn OFF of the IPD 22, the supply of power from the first zone ECU 5 to the first end ECU 7 ends.

The first zone ECU 5 turns ON and OFF the IPD 23 based on the operation control request for the IPD 23 provided from the mobility computer 2 via the communication line 33, and switches over the second end ECU 8 between the power-supplied state and the power-cutoff state. Specifically, by turn ON of the IPD 23, the supply of power from the first zone ECU 5 to the second end ECU 8 starts. By turn OFF of the IPD 23, the supply of power from the first zone ECU 5 to the second end ECU 8 ends.

The first zone ECU 5 turns ON and OFF the IPD 24 based on an operation control request for the IPD 24 provided from the mobility computer 2 via the communication line 33, and switches over the third end ECU 9 between the power-supplied state and the power-cutoff state. Specifically, by turn ON of the IPD 24, the supply of power from the first zone ECU 5 to the third end ECU 9 starts. By turn OFF of the IPD 24, the supply of power from the first zone ECU 5 to the third end ECU 9 starts.

The second PNB 4 and the mobility computer 2 are connected to each other via a power line 59 so that the power is distributable. The second PNB 4 includes an IPD 25 interposed between the power line 54 and the power line 59. The IPD 25 is basically always in ON, and the power from the second battery 16 is always supplied to the mobility computer 2. In the present embodiment, the IPD 25 is basically always ON. However, the IPD 25 may be turned OFF. For example, when the vehicle is not used for a long period of time, for example, for transportation by ship, the IPD 25 may be temporarily turned OFF to reduce a dark current flowing to the mobility computer 2, so that the power consumption of the second battery 16 can be reduced.

When the IPD 25 is temporarily turned OFF, the supply of power from the second battery 16 to the mobility computer 2 is stopped. So that the IPD 25 can be turned from OFF to ON, the mobility computer 2 may operate in a low-power consumption state by a battery during the period of time during which the supply of power to the mobility computer 2 is stopped. The system may be configured so that the mobility computer 2 and the second battery 16 are directly connected so that the power from the second battery 16 is always supplied to the mobility computer 2. In this case, the power line 59 and the IPD 25 may be omitted.

The second PNB 4 and the second zone ECU 6 are connected to each other via a power line 60 so that the power is distributable. The second PNB 4 includes an IPD 26 interposed between the power line 54 and the power line 60. The second PNB 4 turns ON and OFF the IPD 26 based on the operation control request for the IPD 26 provided from the mobility computer 2 via a communication line 34, and switches over the second zone ECU 6 between the power-supplied state and the power-cutoff state. Specifically, by turn ON of the IPD 26, the supply of power from the second PNB 4 to the second zone ECU 6 starts. By turn OFF of the IPD 26, the supply of power from the second PNB 4 to the second zone ECU 6 ends.

The second zone ECU 6 and the fourth end ECU 10 are connected to each other via a power line 61 so that the power is distributable. The second zone ECU 6 and the fifth end ECU 11 are connected to each other via a power line 62 so that the power is distributable. The second zone ECU 6 and the sixth end ECU 12 are connected to each other via a power line 63 so that the power is distributable. The second zone ECU 6 includes the IPD 27 interposed between the power line 60 and the power line 61, the IPD 28 interposed between the power line 60 and the power line 62, and the IPD 29 interposed between the power line 60 and the power line 63.

The second zone ECU 6 turns ON and OFF the IPD 27 based on an operation control request for the IPD 27 provided from the mobility computer 2 via the communication line 34, and switches over the fourth end ECU 10 between the power-supplied state and the power-cutoff state. Specifically, by turn ON of the IPD 27, the supply of power from the second zone ECU 6 to the fourth end ECU 10 starts. By turn OFF of the IPD 27, the supply of power from the second zone ECU 6 to the fourth end ECU 10 ends.

The second zone ECU 6 turns ON and OFF the IPD 28 based on the operation control request for the IPD 28 provided from the mobility computer 2 via the communication line 34, and switches over the fifth end ECU 11 between the power-supplied state and the power-cutoff state. Specifically, by turn ON of the IPD 28, the supply of power from the second zone ECU 6 to the fifth end ECU 11 starts. By turn OFF of the IPD 28, the supply of power from the second zone ECU 6 to the fifth end ECU 11 ends.

The second zone ECU 6 turns ON and OFF the IPD 29 based on the operation control request for the IPD 29 provided from the mobility computer 2 via the communication line 34, and switches over the sixth end ECU 12 between the power-supplied state and the power-cutoff state. Specifically, by turn ON of the IPD 29, the supply of power from the second zone ECU 6 to the sixth end ECU 12 starts. By turn OFF of the IPD 29, the supply of power from the second zone ECU 6 to the sixth end ECU 12 ends.

### Activation stop control in communication system

The communication system 1 combines an activation stop control via a relay based on ON and OFF of the IPD and an activation stop control by switching to the wake-up state or the sleep state based on the communication frame. In the following description, the former of the two activation stop controls is referred to as activation stop control via relay and the latter is referred to as activation stop control based on communication frame. The communication frame described above is also called a NM frame or a NM message. NM is an abbreviation for Network Management.

The activation stop control via relay includes an activation control via relay based on ON of the IPD and a stop control via relay based on OFF of the IPD. The activation stop control based on communication frame includes an activation control by switching over from the sleep state to the wake-up state based on the communication frame for a wake-up request and a stop control by switching over from the wake-up state to the sleep state based on the communication frame for a sleep request.

The activation stop control via relay uses an operation control request, i.e., an IPD ON signal for instructing ON of the IPD and an IPD OFF signal for instructing OFF of the IPD. Specifically, the ECU having received the IPD ON signal from the mobility computer 2 turns ON the IPD specified by the received IPD ON signal and starts supplying the power to the ECU connected to the turned-ON IPD as the power distribution target. The ECU having received the IPD OFF signal from the mobility computer 2 turns OFF the IPD specified by the received IPD OFF signal and ends supplying the power to the ECU connected to the turned-OFF IPD as the power distribution target.

The activation stop control based on communication frame uses the value of a predetermined bit in the data field of the communication frame. For example, the communication frame including "1" at the predetermined bit of the data field is used as the communication frame for a wake-up request, and the communication frame including "0" at the predetermined bit of the data field is used as the communication frame for a sleep request. Specifically, the ECU having received the communication frame from the mobility computer 2 determines the value stored at the predetermined bit of the data field of the received communication frame. If the value is "1", the ECU transitions from the sleep state to the wake-up state or keeps the wake-up state. If the value is "0", the ECU transitions from the wake-up state to the sleep state or keeps the sleep state.

The ECU keeps the wake-up state as long as the ECU periodically receives the communication frame for a wake-up request from the mobility computer 2 at given periods for example. Upon elapse of a certain period of time during which receipt of the communication frame for the wake-up request is absent, the ECU transitions from the wake-up state to the sleep state. The wake-up state may be a normal operating state in which functions assigned to the ECU are available without limitation. The sleep state may be a low-power consumption operating state in which there is a limitation on available functions. The communication frame is not limited to being transmitted from the mobility computer 2 and may also be transmitted from another ECU.

The activation stop control via relay performed by the mobility computer 2 incudes: transmitting the IPD ON signal to an ECU arranged in a higher level than a control target ECU to turn ON the IPD, thereby performing the activation control on the control target ECU; and transmitting the IPD OFF signal to turn OFF the IPD, thereby performing the stop control on the control target ECU. For example, when the control target ECU is the first zone ECU 5, the mobility computer 2 transmits the IPD ON signal to the first PNB 3 arranged in the higher level than the first zone ECU 5 to turn ON the IPD 21, thereby activating the first zone ECU 5, and transmits the IPD OFF signal to turn OFF the IPD 21, thereby stopping the first zone ECU 5.

For example, when the control target ECU is the first end ECU 7, the mobility computer 2 transmits the IPD ON signal to the first zone ECU 5 arranged in the higher level than the first end ECU 7 to turn ON the IPD 22, thereby activating the first end ECU 7, and transmits the IPD OFF signal to turn OFF the IPD 22, thereby stopping the first end ECU 7.

The activation stop control based on communication frame performed by the mobility computer 2 includes: transmitting the communication frame for a wake-up request destined for the control target ECU, thereby transitioning the control target ECU to the sleep state; transmitting the communication frame for a wake-up request destined for the control target ECU, thereby transitioning the control target ECU to the wake-up state. For example, when the control target ECU is the first zone ECU 5, the mobility computer 2 transmits the communication frame for a wake-up request destined for the first zone ECU 5, thereby transitioning the first zone ECU 5 to the wake-up state, and transmits the communication frame for a sleep request destined for the first zone ECU 5, thereby transitioning the first zone ECU 5 to the sleep state.

For example, when the control target ECU is the first end ECU 7, the mobility computer 2 transmits the communication frame for a wake-up request destined for the first end ECU 7, thereby transitioning the first end ECU 7 to the wake-up state, and transmits the communication frame for a wake-up request destined for the first end ECU 7, thereby transitioning the first end ECU 7 to the sleep state. The ECU to which the supply of power has started due to the turn ON of the IPD arranged in the higher level autonomously becomes the wake-up state, and therefore, it is not necessary for the mobility computer 2 to transmit the communication frame for a wake-up request to this ECU.

### Configuration of each ECU

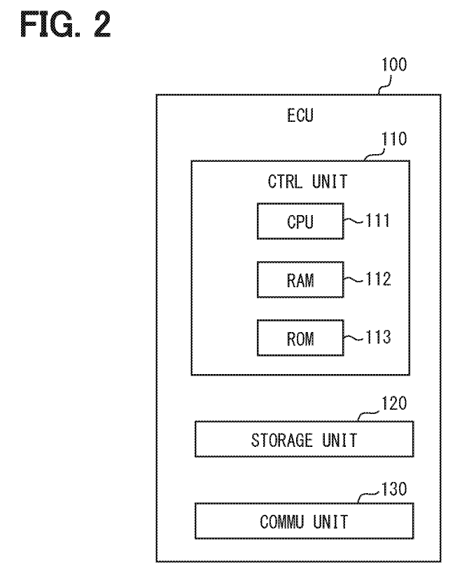

The configuration common to multiple ECUs in the communication system 1 will be described below with reference to FIG. 2. In the following, by way of example, the ECU 100 represents any one of the multiple ECUs to describe the configuration common to the multiple ECUs. As shown in FIG. 2, the ECU 100 includes a control unit 110, a storage unit 120, and a communication unit 130.

The control unit 110 is a device that performs various calculation processes and other processing related to the operation of the ECU 100, etc., and includes a microcomputer as a main component thereof, wherein the microcomputer includes, for example, a CPU 111, a RAM 112, and a ROM 113. In the following description, the microcomputer may be abbreviated as microcomputer. Various functions of the control unit 110 are implemented by the CPU 111 executing a program stored in a non-transitory tangible storage medium. The non-transitory substantive storage medium is, for example, the ROM 113. When the program is executed by CPU 111, a method corresponding to the program is executed.

The number of microcomputers in the control unit 110 may be one or more. Various functions of the control unit 110 are not limited to being implemented by software. Part or all of elements of the functions may be implemented using one or more hardware pieces. For example, when the above function is implemented by a hardware electronic circuit, the electronic circuit may be a digital circuit including a number of logic circuit, or an analog circuit, or a combination of the digital circuit and the analog circuit. The storage unit 120 is, for example, a nonvolatile memory, such as a flash memory or an EEPROM, that can be rewritten with various data. The communication unit 130 controls data communication with another ECU.

### Function of power distribution control device

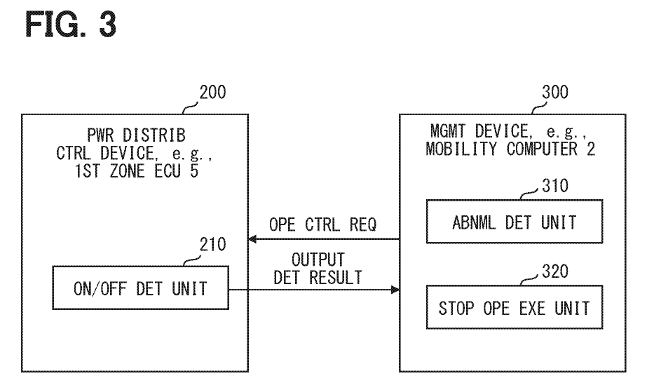

Functions of the power distribution control devices will be described below with reference to FIG. 3, wherein the power distribution control devices are the first PNB 3, the second PNB 4, the first zone ECU 5 and the second zone ECU 6. In the following, by way of example, the power distribution control device 200 represents any one of the first PNB 3, the second PNB 4, the first zone ECU 5, and the second zone ECU 6 to describe the functions of the power distribution control devices.

As shown in FIG. 3, the power distribution control device 200 includes an ON OFF determination unit 210 as a functional block that performs a determination as to ON and OFF of the IPD based on an output value being a value related to an output of the IPD. This functional block can be implemented by software, by hardware, or by collaboration between software and hardware. The output value used by the ON OFF determination unit 210 may be any information on the output of the IPD, for example, may be one or both of a voltage value and a current value of the output of the IPD.

The ON OFF determination unit 210 acquires the output value after a certain period of time has elapsed since receipt of the operation control request transmitted from the mobility computer 2. A reason for waiting the certain period of time before acquiring the output value is to take into account a time taken for the ON or OFF state indicated by the operation control request to be actually reflected to the output of the IPD. The ON OFF determination unit 210 compares the output value with a predetermined threshold and determines whether the IPD is ON or OFF based on the comparison result.

The threshold described above can be set to, for example, a value between the voltage or current value expected when the IPD is ON and the voltage or current value expected when the IPD is OFF. By setting the threshold in this manner, it is possible for the ON OFF determination unit 210 to determine that the IPD is ON when the output value exceeds the threshold and determine that the IPD is OFF when the output value is below the threshold.

The ON OFF determination unit 210 transmits an output determination result indicating a result of this determination to the mobility computer 2. When the ECU is to transition to the sleep state by a stop sequence, the ECU determines, by using the ON OFF determination unit 210, whether the IPD is ON or OFF and transmits a result of the determination to the mobility computer 2 before transitioning to the sleep state.

### Functions of management device

Functions of the mobility computer 2 being the management device will be described below with reference to FIG. 3 to 7. By way of example, the mobility computer 2 represents a management device 300 to describe functions of the management device of the present embodiment. As shown in FIG. 3, the management device 300 includes an abnormality determination unit 310 and a stop operation execution unit 320 as functional blocks. Specifically, in the present embodiment, the abnormality determination unit 310 is provided in the mobility computer 2 being the management device 300. Such functional blocks can be implemented by software, by hardware, or by collaboration between software and hardware.

Based on the output determination result indicating a result of the determination performed by the ON OFF determination unit 210 and the operation control request, the abnormality determination unit 310 determines whether or not there is such an abnormality that the power of the first battery 15 or the second battery 16 is unintentionally consumed. For example, the abnormality may be such that the IPD wrongly becomes an ON state, that the ECU wrongly becomes the wake-up state, etc. In the following, this kind of abnormality is also referred to as a power leakage abnormality.

The abnormality where the IPD wrongly becomes the ON state is also called a power distribution wrong continuation and may be caused due to, for example, a failure of power distribution control via communication, an IPD ON fixation, leakage, rare short circuit, etc. Failure modes where the IPD wrongly becomes the ON state includes a mode where “it is impossible to switch OFF the IPD” and a mode where “the IPD is switched ON regardless of the operation control request". Of these two failure modes, the former is referred to as "impossible to turn OFF" and the latter as "turn ON beyond control".

Factors causing "impossible to turn OFF" includes "IPD is fixed to the ON state" and "IPD ON signal is fixed." It is considered that the factor "IPD is fixed to the ON state" results from an occurrence of an abnormality in the IPD. It is considered that the factor "IPD ON signal is fixed" results from an occurrence of an abnormality in the operation output request from the mobility computer 2, an occurrence of an abnormality in the communication, etc.

Factors causing "turn ON beyond control" include "IPD ON signal is input in a scene where the IPD is supposed to be switched OFF.” It is considered that the factor "IPD ON signal is input in a scene where the IPD is supposed to be switched OFF” results from an occurrence of an abnormality in the operation control request from the mobility computer 2, an occurrence of an abnormality in the communication, generation of noise in a signal transmission path from the mobility computer 2 to the switch of the IPD, etc.

The abnormality where the ECU wrongly becomes the wakeup state is also referred to as an ECU false wake-up, which may be caused by a communication abnormality related to the activation stop control. The abnormality where the ECU wrongly becomes the wake-up state includes "it is impossible to sleep the ECU supposed to be in the sleep state" and "the ECU in the sleep state wakes up beyond control". It is considered that these kinds of anomality result from fixation of NM frames, damaged NM frames, excessive NM frames, etc.

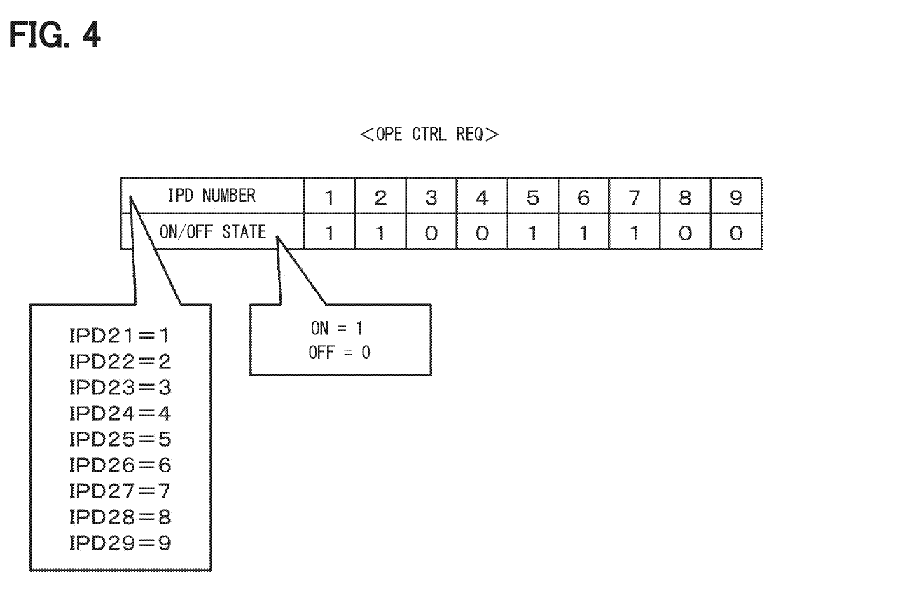

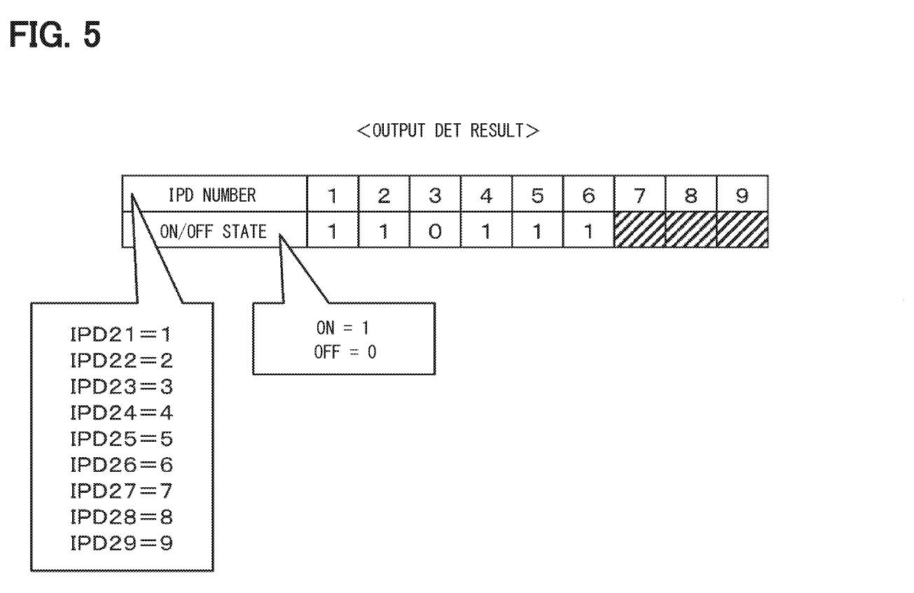

The abnormality determination unit 310 acquires a result of the determination performed by the ON OFF determination unit 210 from the power distribution control device 200 and determines whether or not the power leakage abnormality is present based on the acquired result of the determination and the operation control request generated in the mobility computer 2. The abnormality determination unit 310 may perform the determination as to the power leakage abnormality in the following specific manner. It is assumed in this case that the IPDs 21 to 29, respectively, are assigned unique numbers, sequentially numbered from 1. It is assumed that the operation control request is as shown in FIG. 4 and the output determination result transmitted from the ON OFF determination unit 210 is as shown in FIG. 5. In FIG. 4 and FIG. 5, the number of each IPD is associated with the ON or OFF state of the IPD. In this case, ON is represented by "1" and OFF is represented by "0".

In this case, as shown in FIG. 4, the operation control request is such that: "IPD 21 = ON", "IPD 22 = ON", "IPD 23 = OFF", "IPD 24 = OFF", "IPD 25 = ON", "IPD 26 =ON", "IPD 27 = ON", "IPD 28 = OFF" and "IPD 29 = OFF". On the other hand, as shown in FIG. 5, the output determination result is such that: "IPD 21 = ON", "IPD 22 = ON", "IPD 23 = OFF", "IPD 24 = ON", "IPD 25 = ON", and "IPD 26 = ON". In this case, the output determination result for the IPDs 27 to 29 shown in FIG. 5 using hatching cannot be transmitted from the second zone ECU 6 with the IPDs 27 to 29to the mobility computer 2 due to a communication cutoff, etc., and cannot acquired by the mobility computer 2.

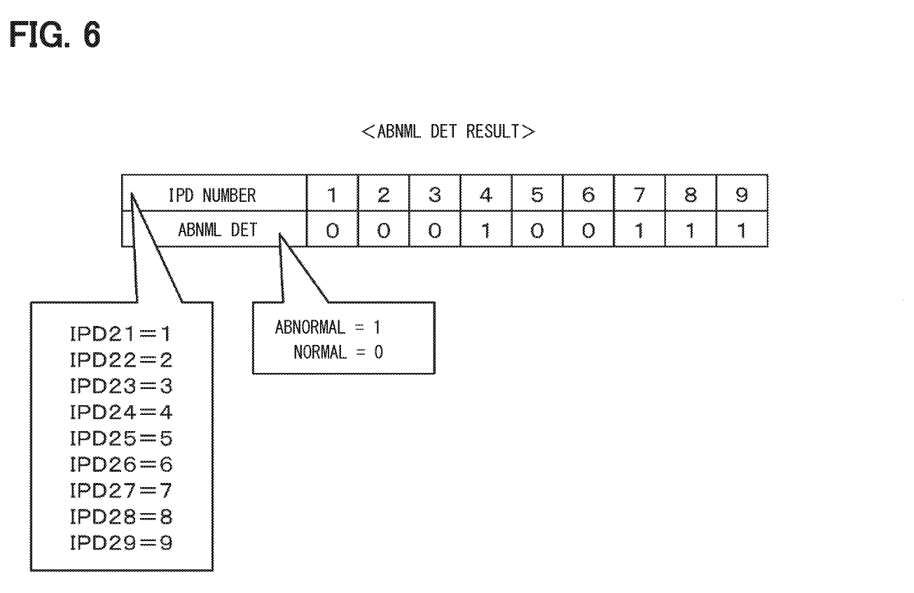

In such a case, the abnormality determination result indicative of the result of the determination by the abnormality determination unit 310 as to the power leakage abnormality is as shown in FIG. 6. In this case,”1” indicates that the abnormality has occurred, i.e., the abnormality is determined as being present, and “0” indicates that the abnormality has not occurred, i.e., the normality is determined as being present. As shown in FIG. 6, with respect to the IPDs 21 to 23, 25, and 26, because the operation control request and the output determination result match each other, the determination result is “0” indicating that the abnormality is absent.

As shown in FIG. 6, with respect to the IPD 24, the operation control request and the output determination result do not match each other, specifically, the operation control request indicates OFF but the output determination result indicates ON, so that the determination result is "1" indicating that the abnormality is present. As shown in FIG. 6, with respect to the IPDs 27 to 29, because the output determination result is not transmitted from the ON OFF determination unit 210, an uncontrollable state is determined and the determination result is “1” indicating that the abnormality is present.

When it is determined by the abnormality determination unit 310 that the power leakage abnormality is present, the stop operation execution unit 320 executes a power distribution stop operation. The power distribution stop operation includes turning OFF the IPD that is located upstream of the location of the power leakage abnormality in the power distribution (i.e., power supplying path) from the first battery 15 or the second battery 16. The power distribution stop operation executed by the stop operation executing unit 320 may further include turning OFF all of IPDs involved in supplying the power to, among the multiple ECUs, ECUs other than ECUs that are necessary to implement predetermined minimum functions. The power distribution stop operation executed by the stop operation executing unit 320 may further include turning OFF all of IPDs involved in supplying the power from the first battery 15.

Upon the stop operation execution unit 320 executing the power distribution stop operation, the stop operation execution unit 320 continues the power distribution stop operation until a next activation that is based on the operation by the user of the vehicle. The stop operation execution unit 320 executes the power distribution stop operation on condition that the state or function of the vehicle meets a predetermined safety condition considered as safe. The safety condition is, for example, such a condition that there is no occupant in the vehicle and the vehicle is in a sleep standby power mode. The safety condition can be modified as needed, as long as the condition is such that even if some functions of the vehicle are stopped as a result of the execution of the power distribution stop operation, a safety issue for the vehicle or vehicle occupant does not arise.

On condition that the safety condition is met, the stop operation execution unit 320 can execute the power distribution stop operation at one of the following two timings, A first timing is a time when the abnormality determination unit 310 determines that the power leakage abnormality is present. In other words, the stop operation execution unit 320 may execute the power distribution stop operation at a time when the abnormality determination unit 310 determines that the power leakage abnormality is present.

A second timing is a time when the remaining battery ratio, in other words, SOC, of the first battery 15 drops to a predetermined threshold after the abnormality determination unit 310 determines that the power leakage abnormality is present. SOC is an abbreviation for State-Of-Charge. In other words, the stop operation execution unit 320 can execute the power distribution stop operation at a time when the remaining battery ratio of the first battery 15 drops to the predetermined threshold after the presence of the abnormality is determined by the abnormality determination unit 310. The above threshold may be set to a value around a restartable value being a value of the first battery15 at which restart is supposed to be possible, more specifically, to the restartable value plus a predetermined margin.

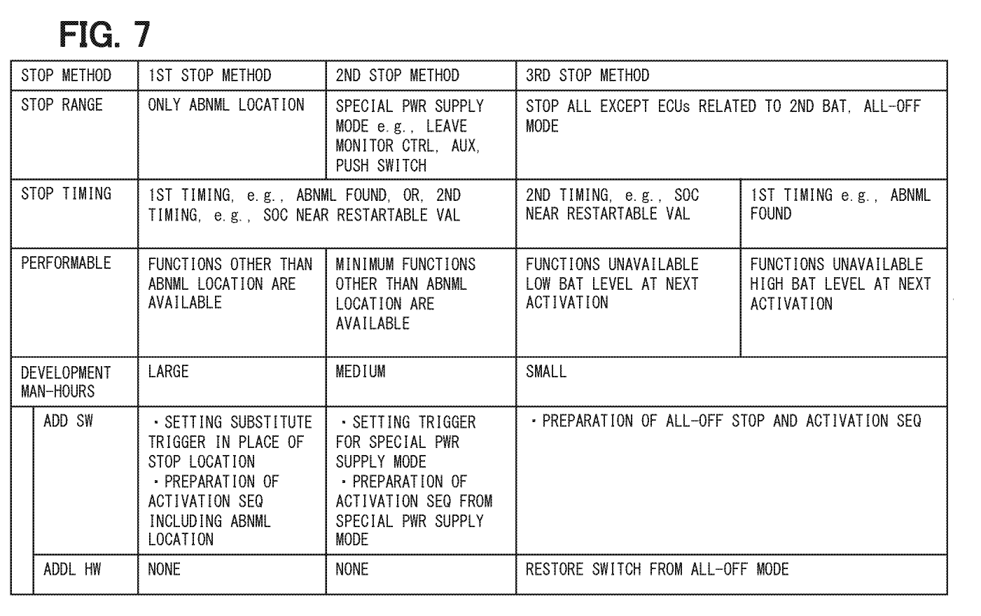

The stop operation execution unit 320 may execute the power distribution stop operation based on any one of three stop methods different in stop range, wherein the stop range is a range of stop of the power distribution. These three stop methods will be described below with reference to FIG. 7.

### 1 First stop method.

In the first stop method, the stop range is only the location of the abnormality. In other words, in this case, as the power distribution stop operation, the stop operation execution unit 320 turns OFF only the IPD that is located upstream of the location of the power leakage abnormality in the power distribution from the first battery 15 or the second battery 16. For example, if the power leakage abnormality is present in the IPD 22, the power distribution stop operation according to the first stop method turns OFF only the IPD 21 located upstream of the location of the power leakage abnormality in the power distribution from the first battery 15. Because of this, the power distribution to the first zone ECU 5, the first end ECU 7, the second end ECU 8 and the third end ECU 9 is stopped.

The power distribution stop operation according to the first stop method may be executed at the first or second timing described above. In other words, in the first stop method, a stop timing, which is the timing to execute the power distribution stop operation, is the first timing or the second timing. When the power distribution stop operation according to the first stop method is executed, functions at and around the location of the power leakage abnormality become unavailable but all other functions are available.

To implement the power distribution stop operation according to the first stop method, the below-described additional software is required, so that development man-hours is the largest among the three stop methods. In FIG. 7, software is abbreviated as SW. The additional software for implementing the power distribution stop operation according to the first stop method includes setting of substitute trigger in place of the stop location, preparation of an activation sequence covering power leakage abnormality location.

### 2 Second stop method.

In the second stop method, the stop range is all ECUs other than (except for) ECUs that are necessary to implement the predetermined minimum functions. The ECUs necessary to implement the predetermined minimum functions include, for example, the mobility computer 2, an auxiliary system ECU and a push-switch system ECU. In other words, in this case, the power distribution stop operation of the stop operation execution unit 320 includes, in addition to turning OFF the IPD in the first stop method, turning OFF all of IPDs involved in supplying the power to, among the multiple ECUs, ECUs other than the ECUs necessary to implement the predetermined minimum functions. In this case, it is assumed that the ECUs necessary to implement the predetermined minimum functions are the mobility computer 2, the second PNB 4 and the sixth end ECU 12. In the following description, a power state of the communication system 1 after execution of the power distribution stop operation according to the second stop method is referred to as a special power mode.

For example, if the power leakage abnormality is present in the IPD 22, the power distribution stop operation according to the second stop method stops the power distribution to the first BMS13 and turns OFF the IPDs 27 and 28 of the second zone ECU 6, in addition to turning OFF the IPD 21 located upstream of the location of the power leakage abnormality in the power distribution from the first battery 15. Because of this, the power distribution to the first BMS 13, the first zone ECU 5, the first end ECU 7, the second end ECU 8, the third end ECU 9, the fourth end ECU 10 and the fifth end ECU 11 is stopped.

The power distribution stop operation according to the second stop method can be executed at the first timing or the second timing described above. In other words, in the second stop method, the stop timing, which is the timing to execute the power distribution stop operation, is the first or second timing. When the power distribution stop operation according to the second stop method is executed, functions at and around the location of the power leakage abnormality and functions other than the minimum functions become unavailable while the minimum functions are available,

To implement the power distribution stop operation according to the second stop method, the following additional software is required, so that the development man-hours is the second largest among the three stop methods. The additional software for implementing the power distribution stop operation according to the first second method includes setting of the trigger for the special power mode and preparation of an activation sequence from the special power mode.

### 3 Third stop method.

In the third stop method, the stop range is all ECUs other than the ECUs related to the second battery 16. Specifically, as the power distribution stop operation, the stop operation execution unit 320 turns OFF all IPDs involved in supplying the power from the first battery 15 in addition to turning OFF the IPD in the first stop method. In this case, it is assumed that the ECUs related to the second battery 16 are the second BMS 14 and the second PNB 4. In the following description, the power state of the communication system 1 after execution of the power distribution stop operation according to the third stop method is also referred to as All-OFF mode.

For example, if the power leakage abnormality is present in the IPD 22, the power distribution stop operation according to the third stop method stops the power distribution to the first BMS13 and turns OFF the IPD 26 in the second PNB 4, in addition to turning OFF the IPD 21 located upstream of the location of the power leakage abnormality in the power distribution from the first battery 15. Because of this, the power distribution to the first BMS 13, the first zone ECU 5, the second zone ECU 6, the first end ECU 7, the second end ECU 8, the third end ECU 9, the fourth end ECU 10, the fifth end ECU 11 and sixth end ECU 12 is stopped.

The power distribution stop operation according to the third stop method may be executed at the first timing or the second timing described above. In other words, in the third stop method, the stop timing, which is the timing to execute the power distribution stop operation, is the first or second timing. When the power distribution stop operation according to the third stop method is executed at the first timing, all IPDs involved in supplying the power from first batter 15 are turned OFF immediately after the abnormality determination unit 310 determines that the power leakage abnormality is present, and therefore, the power distribution is stopped in a state where the remaining battery ratio of the first battery 15, i.e., the remaining level, is relatively high. When the power distribution stop operation according to the third stop method is executed at the second timing, the power distribution is stopped after the remaining battery level, i.e., the remaining battery ratio, of the first battery 15 drops to the value around the restartable value.

If the power distribution stop operation according to the third stop method is executed, various functions become unavailable. If the power distribution stop operation according to the third stop method is executed at the first timing, the remaining battery level of the first battery 15 is relatively high at the next activation. On the other hand, if the power distribution stop operation according to the third stop method is executed at the second timing, the remaining battery level of the first battery 15 is relatively low at the next activation.

Additional software and hardware for implementing the power distribution stop operation according to the third stop method are relatively small, so that the development man-hours are the smallest among the three stop methods. In FIG. 7, hardware is abbreviated as HW. The additional SW for implementing the power distribution stop operation according to the third stop method includes preparation of All-OFF stop and activation sequences. The additional HW for implementing the power distribution stop operation according to the third stop method includes a switch to restore from the All-OFF mode.

### Flow of series of operations related to power leakage abnormality

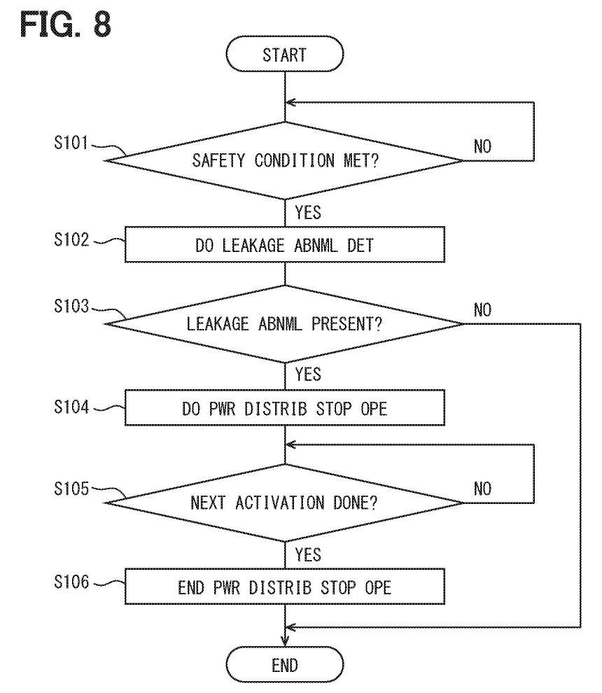

A flow of series of operations by the communication system 1 related to the power leakage abnormality is, for example, as shown in FIG. 8. first, in step S101, it is determined whether or not the safety condition is met. Cases where the safety condition is not met includes a case where the vehicle is running and a case where the vehicle is in a stopped state and an occupant is present in the vehicle. When the safety condition is not met, step S101 results in “NO“ and step S101 is repeated.

Cases where the safety condition is met includes a case where the vehicle is in the sleep standby power mode and the occupant is absent in the vehicle. When the safety condition is met, step S101 results in “YES“ and the process proceeds to step S102. In step S102, the abnormality determination unit 310 executes the determination as to the power leakage abnormality. After executing step S102, the process proceeds to step S103. In step S103, it is determined whether or not a result of determination by the abnormality determination unit 310 is the presence of the power leakage abnormality.

When it is determined that the power leakage abnormality is absent, step S103 results in “NO”, and this series of processes is ended. When it is determined that the power leakage abnormality is present, step S103 results in “YES”, and the process proceeds to step S104. In step S104, the power distribution stop operation is executed by the stop operation execution unit 320. At this time, the communication system 1 may notify a vehicle user of occurrence of the power leakage abnormality.

After execution of step S104, the system proceeds to step S105. In step S105, it is determined whether or not the next activation due to a user operation has been performed. When the next activation has not been performed, step S105 results in "NO" and step S105 is repeated. When the next activation has been performed, step S105 results in "YES” and the process proceeds to step S106. In step S106, the power distribution stop operation is ended. Specifically, the power distribution stop operation executed in step S104 is continued until step S106 is executed. After execution of step S106, this series of processes is ended.

The above-described embodiment provides the following effect.

In the communication system 1 of the present embodiment, the function of the abnormality determination unit 310 makes it possible to detect the occurrence of such an abnormality that the IPD wrongly becomes the ON state, in other words, the ECU supposed to be stopped becomes active. In the communication system 1, when the occurrence of the above-mentioned abnormality is detected, the power distribution stop operation is executed by the stop operation execution unit 320 of the mobility computer 2. Because of this, the ECU supposed to be stopped is stopped by cutoff of the supplied power. The communication system 1 of the present embodiment can reliably stop unnecessary functions. Therefore, according to the present embodiment, even in the event of an abnormality related to the IPD or communication, the first battery 15 and the second battery 16 can be prevented from running out of battery power.

The stop operation execution unit 320 of the mobility computer 2 is configured to execute the power distribution stop operation on the condition that a state or function of the vehicle meets a predetermined condition considered as safe. In this way, even if at least part of the functions is stopped due to the execution of the power distribution stop operation, a safety issue for the vehicle or vehicle occupants can be prevented from arising.

The stop operation execution unit 320 can execute the power distribution stop operation based on any one of the first stop method, the second stop method and the third stop method different in stop range from each other. In the first stop method, as the power distribution stop operation, the stop operation execution unit 320 turns OFF only the IPD that is located upstream of the location of the power leakage abnormality in the power distribution from the first battery 15 or the second battery 16. Execution of the power distribution stop operation according to the first stop method provides such an effect that although the functions at and around the location of the power leakage abnormality become unavailable, all other functions are available.

In the second stop method, as the power distribution stop operation, the stop operation execution unit 320 turns OFF all of IPDs involved in supplying the power to, among the multiple ECUs, ECUs other than the ECUs necessary to implement predetermined minimum functions, in addition to turning OFF the IPD in the first stop method. Execution of the power distribution stop operation according to the second stop method provides such an effect that although the functions at and around the location of the power leakage abnormality become unavailable and other functions except for the minimum functions become unavailable, the minimum functions are available.

In the third stop method, as the power distribution stop operation, the stop operation execution unit 320 turns OFF all IPDs involved in supplying the power from the first battery 15 in addition to turning OFF the IPD in the first stop method. The power distribution stop operation according to the third stop method provides such an effect that the development man-hours can be reduced because addition of software and hardware for implementing the power distribution stop operation according to the third stop method is smaller than that for implementing the power distribution stop operation according to the first stop method and the second stop method. The third stop method also has an advantage of being highly versatile because the third stop method does not depend on a difference in vehicle system configuration.

After the stop operation execution unit 320 of the mobility computer 2 executes the power distribution stop operation, the power leakage abnormality may be resolved but there may be a situation where the power leakage abnormality continues without being resolved. In such a case, if, after execution of the power distribution stop operation, the power distribution stop operation is ended due to performing activation (restart) by the communication system 1, unnecessary power consumption caused by the power leakage abnormality will occur again. In view of this, upon the execution unit 320 of the mobility computer 2 executing the power distribution stop operation, the power distribution stop operation continues until the next activation based on the user operation. In this way, it is possible to minimize unnecessary power consumption in a case where the power leakage abnormality is not resolved.

The stop operation execution unit 320 can execute the power distribution at either the first timing or the second timing, wherein the first timing is a time when the abnormality determination unit 310 determines that the power leakage abnormality is present and the second timing is a time when the SOC of the first battery 15 drops to a predetermined threshold after the abnormality determination unit 310 determines that the power leakage abnormality is present. In a configuration where the power distribution stop operation is executed at the first timing, the target IPD is turned OFF immediately after the abnormality determination unit 310 determines that the power leakage abnormality is present, so that the power distribution is stopped in a state where the remaining battery level of the first battery 15 is relatively high. Thus, it is possible to provide a state where the remaining battery level of the first battery 15 is relatively high at the next startup.

In a configuration where the power distribution stop operation is executed at the second timing, the power distribution is stopped after the SOC of the first battery 15 drops to a value around the restartable value. Therefore, in a configuration where the power distribution stop operation is executed at the second timing, it is possible to continue using the power of the first battery 15 until the stop of the power distribution to the extent that the SOC of battery 1.15 does not fall below the restartable threshold.

### Modifications on power supply path

In the above, the stop operation execution unit 320 executes the power distribution stop operation based on any one of the first, second, and third stop methods having different stop ranges. However, the first, stop method, the second stop method, and the third stop methods may be executed in combination. For example, upon the abnormality determination unit 310 determining that the power leakage abnormality is present, the stop operation execution unit 320 may first execute the power distribution stop operation according to the first stop method, and after elapse of a given time, execute the power distribution stop operation according to the second stop method, and after elapse of a given time, execute the power distribution stop operation according to the third stop method.

### Modifications on configuration of communication system

As long as the communication system 1 is mounted on a movable object and includes multiple ECUs arranged so that communication is performable therebetween, the communication system 1 may be modified in the following way for example. In place of the mobility computer 2, an ECU that is a mobility computer with built-in IPD that has the functions of both the mobility computer and the zone ECU may be used. In place of the mobility computer 2, an ECU that is a mobility computer with built-in IPD that has both the functions of the mobility computer and the functions of the first PNB 3 or the second PNB 4 may be used. In these cases, the mobility computer with built-in IPD, which has a relay, functions as both the management device and the power distribution control device, and therefore, both the determination by the ON OFF determination unit and the determination by the abnormality determination unit can be performed by the mobility computer with built-in IPD. Thus, the management device and the power distribution control device are integrated into a single ECU.

In place of the first zone ECU 5 and the second zone ECU 6, multiple domain control units may be used. In this case, the domain control unit functions as the power distribution control device. In this case, the mobility computer 2 may be absent in the communication system, and any one of the domain control units may have a master function in an architecture where the multiple domain control units coexist. In such a configuration, the domain control unit having the master function functions as the management device and the other domain control unit functions as the power distribution control device.

### Second Embodiment

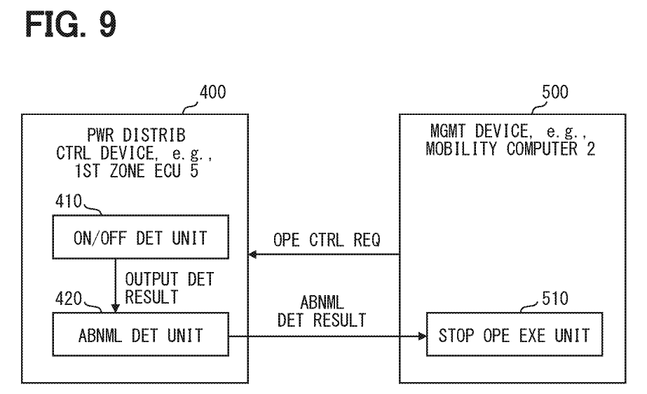

A second embodiment will be described below with reference to FIG. 9. The second embodiment is a modification of the first embodiment with respect to functions of the power distribution control device and the management device.

### Function of power distribution control device

The functions of the first PNB 3, the second PNB 4, the first zone ECU 5 and the second zone ECU 6 each being the power distribution control devices will be described below with reference to FIG. 9. By way of example, a power distribution control device 400 represents any one of the first PNB 3, the second PNB 4, the first zone ECU 5, and the second zone ECU 6 to describe a function of the power distribution control device of the present embodiment.

As shown in FIG. 9, the power distribution control device 400 includes an ON OFF determination unit 410 and an abnormality determination unit 420 as functional blocks. In other words, in the present embodiment, the abnormality determination unit 420 is provided in the power distribution control device 400. The ON OFF determination unit 410 has generally the same function as the ON OFF determination unit 210 of the first embodiment, except that the output determination result indicative of the result of the determination is transmitted to the abnormality determination unit 420 instead of the mobility computer 2.

The abnormality determination unit 420 has generally the same functions as the abnormality determination unit 310 of the mobility computer 2 in the first embodiment, except that the abnormality determination unit 420 acquires the result of determination from the ON OFF determination unit 410. The abnormality determination unit 420 determines whether or not the power leakage abnormality is present based on the result of the determination by the ON OFF determination unit 410 and the operation control request. The abnormality determination unit 420 transmits the abnormality determination result, which is the result of the determination as to the power leakage abnormality, to the mobility computer 2 for notification.

### Functions of the management device

The function of the mobility computer 2 being the management device will be described below with reference to FIG. 9. By way of example, a management device 500 represents the mobility computer 2 to describe the function of the management device of the present embodiment. As shown in FIG. 9, the management device 500 includes a stop operation execution unit 510 as a functional block. The stop operation execution unit 510 has generally the same functions as the stop operation execution unit 320 of the first embodiment, except that the stop operation execution unit 510 acquires the abnormality determination result from the abnormality determination unit 420 of the power distribution control device 400.

In the present embodiment, like the first embodiment, the function of the abnormality determination unit 420 makes it possible to detect the occurrence of such an abnormality that the IPD wrongly becomes the ON state, and upon detection of the abnormality, the power distribution stop operation is executed by the stop operation execution unit 510 of the mobility computer 2. Therefore, as in the first embodiment, the present embodiment can prevent the first battery 15 and second battery 16 from running out of battery power even in the event of occurrence of the abnormality related to IPD or communication.

### Other Embodiments

The present disclosure is not limited to the embodiments described above and illustrated in the drawings. Various modifications, combinations and extensions are possible without departing from the spirit and scope of the present disclosure.

The numerical values and the like shown in the above embodiments are examples. The present disclosure is not limited the examples.

While the present disclosure has been described with reference to embodiments thereof, it is to be understood that the disclosure is not limited to the embodiments and constructions. The present disclosure encompasses various examples and modifications within an equivalent range. In addition, various combinations and forms, including more, less or only a single element, are also within the sprit and the scope of the present disclosure.

The control units and the methods thereof described in the present disclosure may be implemented by a dedicated computer provided by configuring a processor and a memory programmed to execute one or multiple functions embodied by a computer program. The control units and the methods thereof described in the present disclosure may be implemented by a dedicated computer provided by configuring a processor with one or more dedicated hardware logic circuits. The control units and the methods thereof described in the present disclosure may be implemented by a dedicated computer provided by configuring a processor and a memory programmed to execute one or multiple functions in combination with a processor configured with one or more dedicated hardware logic circuits. The computer program may be stored on a computer-readable non-transitory tangible storage medium as instructions executed by a computer.

What is claimed is:

1. A communication system mounted on a movable object, comprising
a plurality of electronic control units arranged so that communication is performable therebetween, wherein
each of the plurality of electronic control units is activated by receiving power supplied from a power supply via a relay and is stopped by cutoff of the supplied power, and
the plurality of electronic control units includes:
a power distribution control device including the relay; and
a management device that generates an operation control request for controlling operation of the relay and outputs the operation control request to the power distribution control device via the communication,
wherein:
the power distribution control device includes an ON OFF determination unit that performs a determination as to ON and OFF of the relay based on an output value being a value related to an output of the relay;
the management device or the power distribution control device includes an abnormality determination unit that determines whether or not there is an abnormality in which the relay wrongly becomes an ON state, based on a result of the determination by the ON OFF determination unit and the operation control request;
upon the abnormality determination unit determining that there is the abnormality, the management device executes a power distribution stop operation including turning OFF the relay that is located upstream of a location of the abnormality in power distribution from the power supply; and
the power distribution control device, the management device, the ON OFF determination unit and the abnormality determination unit are each provided by at least a processor and a memory.

2. The communication system according to claim 1, wherein:
the management device executes the power distribution stop operation on condition that a state or function of the movable object meets a predetermined condition considered as safe.

3. The communication system according to claim 1, wherein:
the power distribution stop operation executed by the management device further includes turning OFF every relay that relates to, among the plurality of electronic control units, an electronic control unit other than an electronic control unit that is necessary to implement a predetermined minimum function.

4. The communication system according to claim 1, wherein:
the power supply includes a high-voltage power supply having a relatively high voltage value and a low-voltage power supply having a relatively low voltage value; and
the power distribution stop operation executed by the management device further includes turning OFF every relay that is involved in supplying the power from the high-voltage power supply.

5. The communication system according to claim 1, wherein:
upon execution of the power distribution stop operation, the management device continues the power distribution stop operation until a next activation that is based on a user operation.

6. The communication system according to claim 1, wherein:
the abnormality determination unit is included in the management device; and
the abnormality determination unit acquires the result of the determination by the ON OFF determination unit from the power distribution control device and determines whether or not there is the abnormality based on the acquired result of the determination and the operation control request.

7. The communication system according to claim 1, wherein:
the abnormality determination unit is included in the power distribution control device;
the abnormality determination unit determines whether or not there is the abnormality based on the result of the determination by the ON OFF determination unit and the operation control request; and
the abnormality determination unit notifies the management device of a result of determining whether or not there is the abnormality.

8. The communication system according to claim 1, wherein:
the management device executes the power distribution stop operation at a time when the abnormality determination unit determines that there is the abnormality.

9. The communication system according to claim 1, wherein:
the management device executes the power distribution stop operation at a time when a remaining battery rate of the power supply drops to a given threshold after the abnormality determination unit determines that there is the abnormality.

10. The communication system according to claim 1, wherein:
the management device and the power distribution control device are integrated into a single one of the electronic control units.
